(19) United States
(12) Patent Application Publication
(10) Pub. No.: US 2026/0184247 A1
(43) Pub. Date: Jul. 2, 2026

(54) VEHICLE SEAT

(71) Applicants: TS TECH CO., LTD., Asaka-shi (JP); HONDA MOTOR CO., LTD., Tokyo (JP)

(72) Inventors: Takahiro INABA, Tochigi (JP); Junichi KOYAMA, Tochigi (JP); Manabu MATSUMOTO, Tokyo (JP)

(21) Appl. No.: 19/430,670

(22) Filed: Dec. 23, 2025

(30) Foreign Application Priority Data
Dec. 26, 2024 (JP) 2024-230828

(51) Int. Cl. B60N 2/68

(52) U.S. Cl. CPC B60N 2/68

(57) ABSTRACT

A vehicle seat including a frame part, and an electrical component attached to the frame part. The frame part includes a frame main body and reinforcement portion reinforcing the frame main body, the electrical component includes an electrical component main body and a wiring portion connected to the electrical component main body, at least a portion of the electrical component main body is attached so as to overlap the frame main body and the reinforcement portion in a front view as viewed from a front, and the wiring portion is supported by the reinforcement portion.

### CROSS-REFERENCE TO RELATED APPLICATION

This application is based upon and claims the benefit of priority from Japanese Patent Application No. 2024-230828 filed on Dec. 26, 2024, the content of which is incorporated herein by reference.

### BACKGROUND OF THE INVENTION

### Field of the Invention

This invention relates to a vehicle seat to which an electrical component is attached.

### Description of the Related Art

In recent years, vehicle seats to which various electrical components are integrally attached have been known in order to improve convenience and comfort when a user is seated. Such a vehicle seat is described, for example, in Japanese Unexamined Patent Publication No. 2008-092989 (JP 2008-092989 A). In the vehicle seat described in JP 2008-092989 A, a speaker system is attached to a seat back that supports the back of the seated person, and audio is output toward the seated person from behind the seated person.

Meanwhile, in order to further improve convenience and comfort for the seated person, the number of electrical components provided in the seat increases, and the number of wires connected to the respective electrical components also increases. As the number of wires increases, bending loads and the like are more likely to act on the wires housed inside the seat, making it difficult to arrange the wires while suppressing such bending loads.

### SUMMARY OF THE INVENTION

An aspect of the present invention is a vehicle seat including a frame part, and an electrical component attached to the frame part. The frame part includes a frame main body and reinforcement portion reinforcing the frame main body, the electrical component includes an electrical component main body and a wiring portion connected to the electrical component main body, at least a portion of the electrical component main body is attached so as to overlap the frame main body and the reinforcement portion in a front view as viewed from a front, and the wiring portion is supported by the reinforcement portion.

### BRIEF DESCRIPTION OF THE DRAWINGS

The objects, features, and advantages of the present invention will become clearer from the following description of embodiments in relation to the attached drawings, in which:

FIG. 1 is a front view of a vehicle seat according to an embodiment of the present invention;

FIG. 2 is a perspective view of the seat in a state where a cover material, a seat back pad, and a garnish are removed from a seat back;

FIG. 3 is an exploded perspective view of the seat in a state where the cover material and the seat back pad are removed from the seat back;

FIG. 4 is a perspective view illustrating a reinforcement plate reinforcing a frame main body as viewed from a rear;

FIG. 5 is a perspective view illustrating a headrest holding portion and a garnish attachment portion;

FIG. 6 is a perspective view illustrating a trim grill included in the garnish as viewed from the rear;

FIG. 7A is a perspective view illustrating a grill guide included in the garnish as viewed from a front;

FIG. 7B is a perspective view of the grill guide of FIG. 7A as viewed from the rear;

FIG. 8A is a perspective view illustrating an inner garnish included in the garnish as viewed from the front;

FIG. 8B is a perspective view of the inner garnish of FIG. 8A as viewed from the rear;

FIG. 9 is a front view illustrating configurations of a speaker system fixed to a seat back frame and its surrounding portions;

FIG. 10A is a view of a first extension portion of a rear casing that fixes a speaker device as viewed from above;

FIG. 10B is an enlarged view of the first extension portion illustrated in FIG. 10A;

FIG. 11A is a sectional view illustrating a state where the grill guide and the trim grill are in the middle of being attached to the inner garnish;

FIG. 11B is a sectional view illustrating a state after the grill guide and the trim grill are attached to the inner garnish;

FIG. 12A is a perspective view illustrating a modification of the wiring portion of the speaker system; and

FIG. 12B is a front view illustrating the modification of the wiring portion of the speaker system.

### DETAILED DESCRIPTION OF THE INVENTION

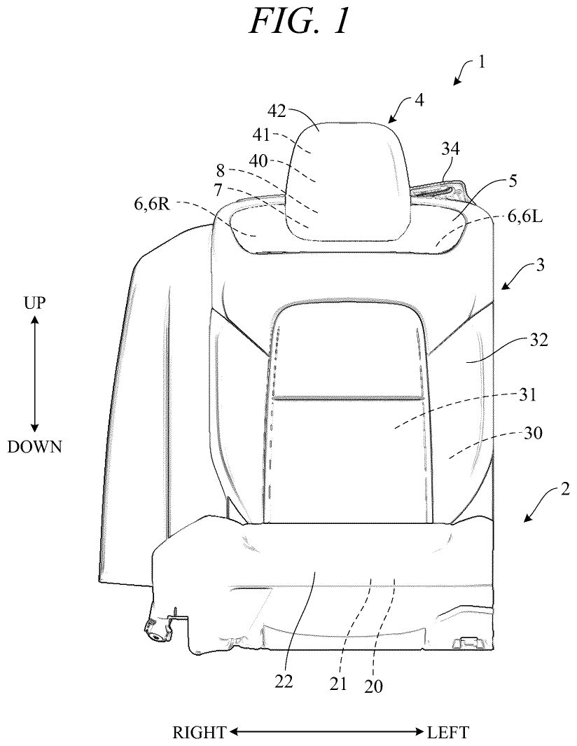

Hereinafter, one embodiment of the present invention will be described with reference to FIGS. 1 to 11B. A vehicle seat according to the present embodiment is a seat in which a garnish and a speaker system (electrical component) are integrally attached to a seat back, and can be used for seats mounted on various vehicles such as aircraft, trains, ships, and automobiles. In the following description, as an example of the vehicle seat, a seat mounted on an automobile, particularly a rear seat that constitutes a rear seat of an automobile (hereinafter simply referred to as a seat) will be used. In addition, in the following description, a front-rear direction, a left-right direction (width direction), and an up-down direction (height direction) are defined based on an occupant (seated person) seated on the seat, and the configuration of each part will be described according to the definition.

FIG. 1 is a front view of a vehicle seat 1 according to an embodiment of the present invention. In FIG. 1, only a right seat (right-side portion) of a rear seat on which three people can sit is illustrated, and illustration of a center seat (center portion) and a left seat (left-side portion) is omitted. Therefore, a description will be given below by using the right seat of the rear seat as the seat 1. As illustrated in FIG. 1, the seat 1 includes a seat cushion 2 that supports the buttocks of an occupant, a seat back 3 that supports an upper body (waist and back) of the occupant, and a headrest 4 that supports the head of the occupant.

The seat cushion 2 is configured by attaching a seat cushion pad 21, which is made of a cushion material such as urethane foam, to a seat cushion frame 20 forming a skeletal structure, and further covering the outer side of the seat cushion pad with a cover material 22 made of synthetic leather or fabric. The seat cushion 2 is supported to be slidable in the front-rear direction by a slide mechanism (not illustrated) provided on the floor of the vehicle.

The seat back 3 is configured by attaching a seat back pad 31, which is made of a cushion material such as urethane foam, to a seat back frame (frame part) 30 forming a skeletal structure, and further covering the outer side of the seat back pad with a cover material 32 made of synthetic leather or fabric. The seat back 3 is rotatably supported by the seat cushion 2 through a reclining mechanism (not illustrated).

The seat back 3 includes a garnish 5 provided at positions corresponding to both shoulders of the seated occupant, and a speaker system 6 installed inside the seat back 3 so as to face the garnish 5. The garnish 5 constitutes a speaker grill of the speaker system 6. The speaker system 6 outputs sound through the garnish 5 from a location near both shoulders of the seated occupant. A specific configuration of the seat back 3 having the garnish 5 and the speaker system 6 will be described later.

The headrest 4 does not include a frame forming a skeletal structure, unlike the seat cushion 2 or the seat back 3, and is configured by filling a cushion pad (headrest main body) 41 made of a cushion material such as urethane foam inside a cover material (headrest main body) 42 made of synthetic leather or fabric, and disposing a headrest pillar 40 inside the cushion pad. The headrest 4 is held on an upper portion of the seat back 3 via the headrest pillar 40, and in this held state, at least a part of the headrest 4 is provided to overlap the garnish 5. In other words, the headrest 4 is provided such that at least a part thereof overlaps a portion of the speaker system 6 in a front view as seen from the front side.

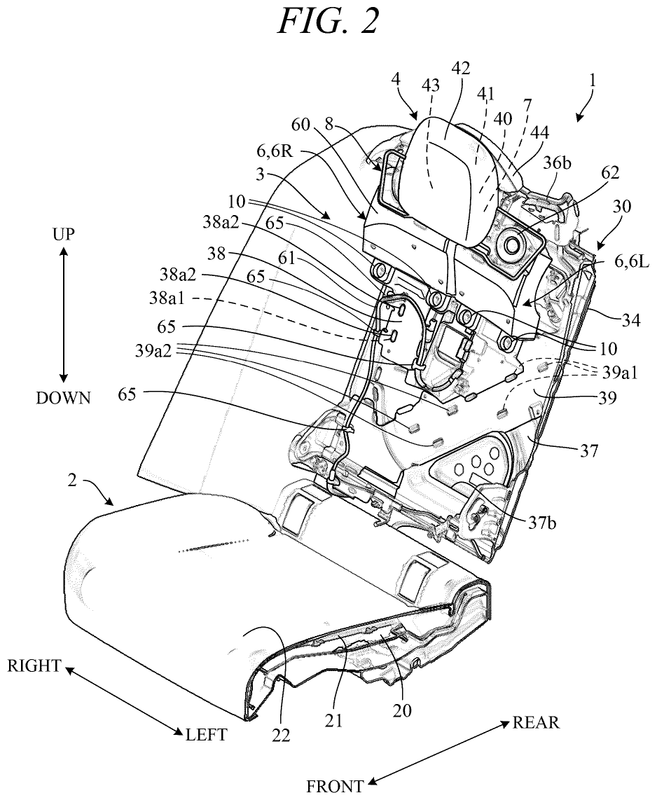

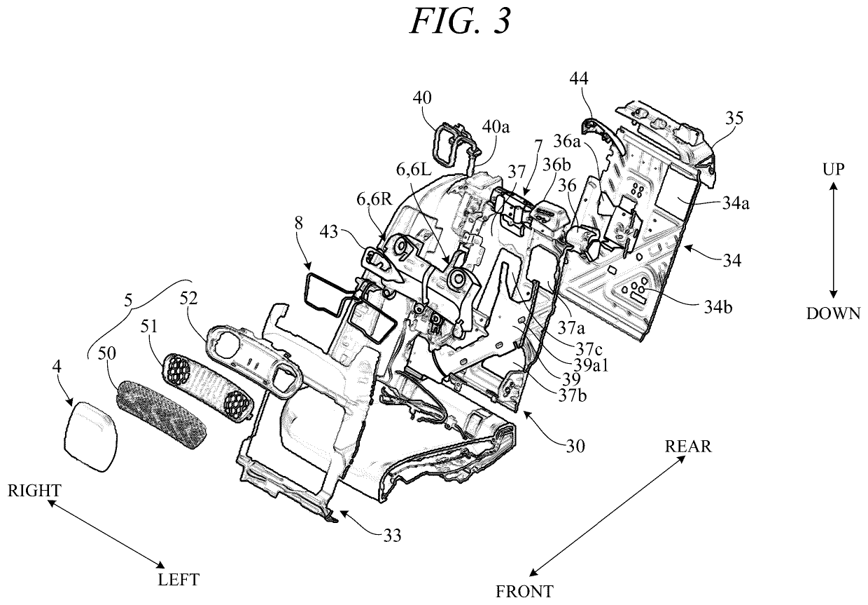

The headrest pillar 40 is formed by bending a bar-shaped metal member and includes a pair of leg portions 40a held by the seat back frame 30 (refer to FIG. 3). The headrest pillar 40 is sandwiched in the front-rear direction by a front headrest cover 43 and a rear headrest cover 44, which are brought into abutment and engaged with each other, and is thereby protected (refer to FIG. 2).

FIG. 2 is a perspective view of the seat 1 in a state where the cover material 32, the seat back pad 31, and the garnish 5 are removed from the seat back 3, and FIG. 3 is an exploded perspective view of the seat 1 in a state where the cover material 32 and the seat back pad 31 are removed from the seat back 3.

As illustrated in FIGS. 2 and 3, the seat back 3 includes the metal seat back frame 30 forming the skeletal structure of the seat back 3, a synthetic-resin front plate 33 provided on a front surface of the seat back frame 30, a synthetic-resin back plate 34 provided on a back surface of the seat back frame 30, a synthetic-resin rear cover 35 provided above the seat back frame 30 and the back plate 34, a belt retractor 36 in which a seat belt is accommodated, the garnish 5 attached to the seat back frame 30, and the speaker system 6 attached to the seat back frame 30 so as to face the garnish 5. In FIG. 2, illustration of the front plate 33 and the rear cover 35 is omitted.

The seat back frame 30 includes a frame main body 37, a reinforcement plate (reinforcement portion) 38 and a reinforcement plate 39 that have a plate shape and reinforce the frame main body 37, a headrest holding portion (holding portion) 7 that is attached to the frame main body 37 and holds the headrest 4, and a garnish attachment portion (attachment portion) 8 that is attached to the frame main body 37 and allows attachment of the garnish 5.

The frame main body 37 is formed in a substantially rectangular plate shape facing the front-rear direction, and includes a first opening portion 37a provided in an upper-left portion, a second opening portion 37b provided in a lower-left portion, a third opening portion 37c provided in a substantially center portion in the left-right direction, and a plurality of ribs (not illustrated). The frame main body 37 is lightened by providing the substantially rectangular first opening portion 37a, second opening portion 37b, and third opening portion 37c, and is reinforced by providing the plurality of ribs. The plurality of ribs are configured, for example, by forming the frame main body 37 into an uneven shape.

The reinforcement plate 38 is joined to the frame main body 37 on the right side of the third opening portion 37c of the frame main body 37 and below the speaker system 6, and reinforces the frame main body 37.

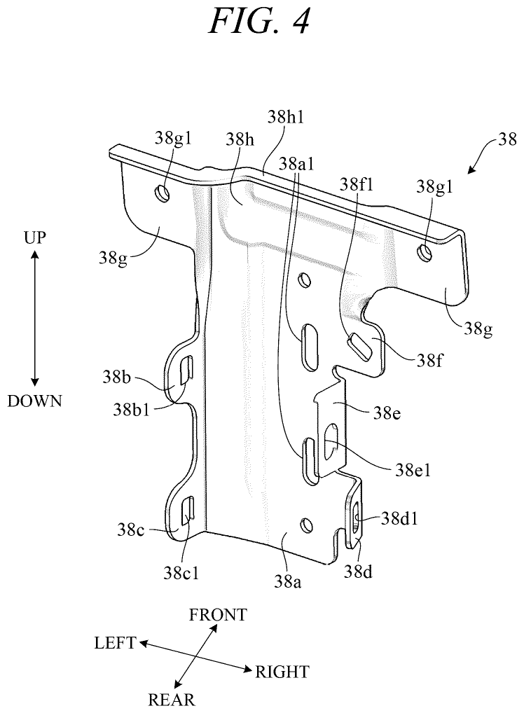

FIG. 4 is a perspective view illustrating the reinforcement plate 38 that reinforces the frame main body 37 as viewed from the rear side. As illustrated in FIG. 4, the reinforcement plate 38 includes a central plate portion 38a formed in a substantially rectangular plate shape facing the front-rear direction; a first extension portion 38b extending rearward from a left-side end portion of a substantially center portion of the central plate portion 38a in the up-down direction; a second extension portion 38c extending rearward from the left-side end portion of the central plate portion 38a at a position below the first extension portion 38b; a third extension portion 38d extending rearward from a right-side end portion of the central plate portion 38a at a position below the first extension portion 38b and above the second extension portion 38c; a fourth extension portion 38e extending rearward from the right-side end portion of the central plate portion 38a at substantially the same position as the first extension portion 38b in the up-down direction; a fifth extension portion 38f extending rightward from the right-side end portion of the central plate portion 38a at a position above the fourth extension portion 38e; a pair of sixth extension portions 38g extending in the left-right direction from the left-side end portion and right-side end portion of the upper end portion of the central plate portion 38a; and a rib 38h provided between the pair of sixth extension portions 38g.

The central plate portion 38a includes a plurality (for example, an upper and lower pair) of joint portions 38a1 that abut against and are joined to the frame main body 37. Each of the plurality of joint portions 38a1 is provided with a through-hole, and the central plate portion 38a is joined to the frame main body 37 by arc welding or the like through the through-holes. FIG. 2 illustrates a plurality of weld beads 38a2 respectively formed on the joint portions 38a1.

The first extension portion 38b, the second extension portion 38c, and the third extension portion 38d respectively include support portions (second support portion, third support portion) 38b1, 38c1, and 38d1 that support a wiring portion 61 (FIG. 2) of the speaker system 6. Each of the support portions 38b1, 38c1, and 38d1 is provided with a through-hole. As illustrated in FIG. 2, clips 65 that support the wiring portion 61 are locked to the support portions 38b1, 38c1, and 38d1. The clip 65 is locked to each of the support portions 38b1, 38c1, and 38d1 such that the wiring portion 61 extends in the up-down direction.

As illustrated in FIG. 4, the fourth extension portion 38e includes a joint portion 38e1 that is joined in a state of abutting against the frame main body 37. A through-hole is provided in the joint portion 38e1, and the fourth extension portion 38e is joined to the frame main body 37 by arc welding or the like through the through-hole.

The fifth extension portion 38f is provided above the joint portion 38a1 on the upper side and includes a support portion (first support portion) 38f1 that supports the wiring portion 61 of the speaker system 6. The support portion 38f1 is provided with a through-hole, and the clip 65 that supports the wiring portion 61 is also locked to the support portion 38f1. While the support portions 38b1, 38c1, and 38d1 support the wiring portion 61 extending in the up-down direction, the support portion 38f1 supports the wiring portion 61 extending in a direction different from the up-down direction, specifically, the wiring portion 61 extending in the left-right direction. That is, the clip 65 is locked to the support portion 38f1 such that the wiring portion 61 extends in the left-right direction.

The pair of sixth extension portions 38g abuts against the frame main body 37. Each of the pair of sixth extension portions 38g is provided with a fixing portion 38g1 that is fixed to the frame main body 37. The fixing portion 38g1 is provided with a through-hole, and, as illustrated in FIG. 2, the sixth extension portion 38g is fixed to the frame main body 37 via a bolt 10 and a nut that pass through the through-hole (not illustrated) formed in the frame main body 37. The speaker system 6 is also fixed to the frame main body 37 by the bolt 10 and the nut via the fixing portion 38g1 of the sixth extension portion 38g and the through-hole (not illustrated) of the frame main body 37.

The rib 38h protrudes toward the seating surface side (front). The reinforcement plate 38 includes an abutting portion 38h1, which is located in the vicinity of the rib 38h and abuts against a lower surface (bottom surface) of the speaker system 6 in a state where the reinforcement plate 38 is joined to the frame main body 37. The abutting portion 38h1 is formed in a substantially plate shape and extends in a horizontal direction. By providing the abutting portion 38h1, positioning of the speaker system 6 when the speaker system 6 is fixed to the frame main body 37 by using the bolt 10 and the nut becomes easier. The rigidity of the reinforcement plate 38 may alternatively be increased by providing a bead or a flange instead of the rib 38h extending forward and having a convex shape.

As illustrated in FIG. 3, the reinforcement plate 39 extends obliquely rightward and downward from a portion, which is below the first opening portion 37a and above the second opening portion 37b on the right side of the frame main body 37, toward a portion below the third opening portion 37c positioned rightward of the first opening portion 37a, and is joined to the frame main body 37. In other words, the reinforcement plate 39 extends obliquely from between the first opening portion 37a and the second opening portion 37b so as to avoid the third opening portion 37c, thereby reinforcing the frame main body 37.

The reinforcement plate 39 is formed in a plate shape so as to be capable of abutting against the frame main body 37, and the reinforcement plate 39 is provided with a plurality of joint portions 39a1 that are joined in a state of abutting against the frame main body 37. Each of the plurality of joint portions 39a1 is provided with a through-hole, and the reinforcement plate 39 is joined to the frame main body 37 by arc welding or the like through the through-holes. FIG. 2 illustrates a plurality of weld beads 39a2 respectively formed on the plurality of joint portions 39a1 by welding. At least some of the plurality of joint portions 39a1, that is, at least some of the plurality of weld beads 39a2, are provided along an extending direction of the reinforcement plate 39.

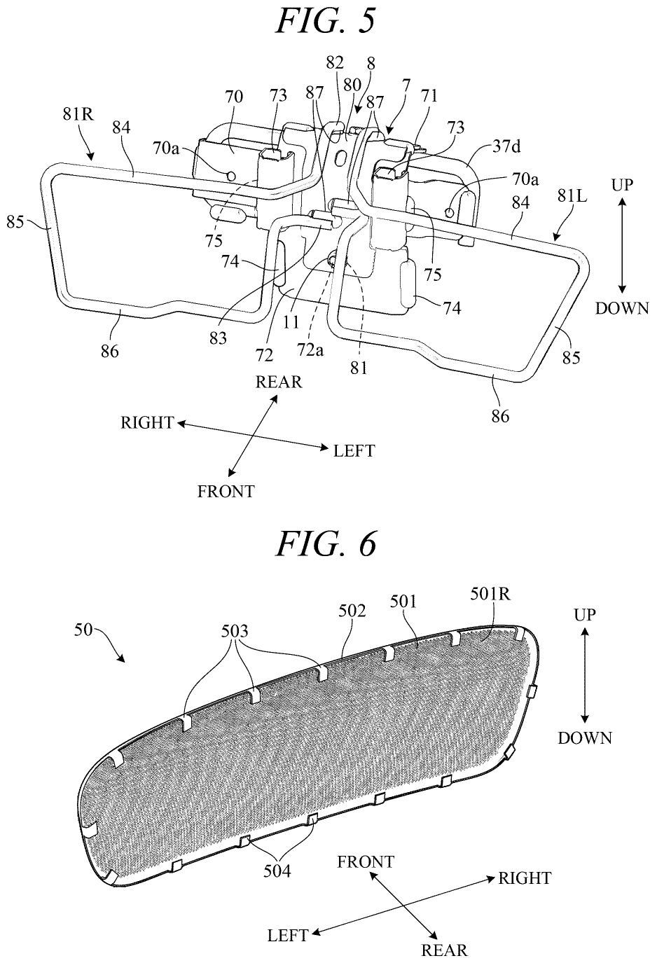

The headrest holding portion 7 and the garnish attachment portion 8 are attached to the frame main body 37 at a substantially center portion of the upper end portion of the frame main body 37 in the left-right direction so as to overlap each other in the front-rear direction. Specifically, the headrest holding portion 7 is arranged behind the garnish attachment portion 8, and a support bar 37d (FIG. 5) joined to the frame main body 37 is arranged behind the headrest holding portion 7. The headrest holding portion 7 and the garnish attachment portion 8 are attached to the frame main body 37 via the support bar 37d. The support bar 37d is formed in a substantially U shape by bending a bar-shaped member (FIG. 5), and is joined to the frame main body 37.

FIG. 5 is a perspective view illustrating the headrest holding portion 7 and the garnish attachment portion 8 as viewed from the front obliquely. As illustrated in FIG. 5, the headrest holding portion 7 includes: a rectangular plate-shaped holding portion main body 70 extending in the left-right direction, a first extension portion 71 extending rearward from an upper end portion of the holding portion main body 70, a second extension portion 72 extending downward from a lower end portion of the holding portion main body 70, and a pair of left and right pillar guide portions 73 provided on a front surface of the holding portion main body 70 and supporting the pair of leg portions 40a of the headrest pillar 40.

The holding portion main body 70 has fixing portions 70a for fixing the speaker system 6, on both sides in the left-right direction. The fixing portion 70a is provided with a through-hole, and the speaker system 6 is fixed to the fixing portions 70a of the holding portion main body 70 by using bolts and nuts. The first extension portion 71 extends rearward from a substantially center portion of the holding portion main body 70 in the left-right direction so as to abut against the upper surface of the support bar 37d, and is joined to the upper surface of the support bar 37d by arc welding or the like. The second extension portion 72 is formed to be capable of abutting against the frame main body 37, and includes a fixing portion 72a for the fixation to the frame main body 37. The fixing portion 72a is provided with a through-hole, and the headrest holding portion 7 is fixed to the frame main body 37 by using a bolt and a nut 11 inserted through this through-hole and a through-hole (not illustrated) formed in the frame main body 37. As illustrated in FIG. 5, weld beads 74 are provided at both end portions of the second extension portion 72 in the left-right direction, and the headrest holding portion 7 is further welded to the frame main body 37 at both end portions of the second extension portion 72 in the left-right direction.

The pair of left and right pillar guide portions 73 is provided at substantially the center portion of the holding portion main body 70 in the left-right direction at a predetermined distance from each other in the left-right direction, and is formed in a substantially cylindrical shape such that the pair of left and right leg portions 40a (FIG. 3) can be inserted therethrough. In FIG. 5, weld beads 75 are illustrated behind the pillar guide portions 73, and the pair of left and right pillar guide portions 73 is welded to the holding portion main body 70.

The garnish attachment portion 8 includes an attachment portion main body 80 that is fixed to the headrest holding portion 7, and a pair of right and left wire portions (wires) 81R and 81L. The attachment portion main body 80 has a rectangular plate shape extending in the up-down direction, and is disposed between the pair of left and right pillar guide portions 73. The attachment portion main body 80 has a fixing portion 81 at a position facing the fixing portion 72a of the second extension portion 72. The fixing portion 81 is provided with a through-hole, and the attachment portion main body 80 is fixed to the frame main body 37 by the bolts and the nuts 11 that are inserted through the fixing portion 72a (through-hole) of the second extension portion 72 and a through-hole (not illustrated) of the frame main body 37.

Each of the pair of right and left wire portions 81R and 81L is formed by bending a single wire. In the wire portions 81R and 81L, one end portion 82 is welded to an upper portion of the attachment portion main body 80, and the other end portion 83 is welded to a substantially center portion of the attachment portion main body 80 in the up-down direction. FIG. 5 illustrates weld beads 87 of the end portions 82 and 83 of the wire portions 81R and 81L. Each of the pair of right and left wire portions 81R and 81L includes an upper wire 84 that engages with an upper portion of the garnish 5, a side wire 85 that engages with a side portion of the garnish 5, and a lower wire 86 that engages with a lower portion of the garnish 5. The upper wire 84 and the lower wire 86 extend in the left-right direction, and the side wire 85 extends in the up-down direction.

As illustrated in FIG. 3, the front plate 33 is attached to the front surface of the seat back frame 30. The front plate 33 covers a portion of the seat back frame 30 and a portion of components supported by the seat back frame 30, thereby protecting components and the like. Together with the seat back pad 31 (FIG. 1), the seat back frame 30, the rear cover 35, and the like, the front plate 33 forms the outer shape of the seat back 3.

The back plate 34 is attached to the back surface of the seat back frame 30. The back plate 34 covers a portion of the seat back frame 30 and a portion of components supported by the seat back frame 30, thereby protecting components and the like. The back plate 34 includes an opening portion 34a provided to face the first opening portion 37a of the frame main body 37, and a covering portion 34b that covers the second opening portion 37b of the frame main body 37. A portion of the third opening portion 37c of the frame main body 37 is also covered by the back plate 34. By the back plate 34, impacts acting on the seat back 3 from the rear side, for example from a trunk room positioned behind the seat back 3, are mitigated.

The rear cover 35 is attached to the upper portions of the seat back frame 30 and the back plate 34. The rear cover 35 covers the upper portions of the seat back frame 30 and the back plate 34, as well as components provided in these upper portions, thereby protecting the components and the like. Specifically, the rear cover 35 covers portions of the headrest holding portion 7 and the garnish attachment portion 8. Together with the seat back pad 31, the front plate 33, and the like, the rear cover 35 forms the outer shape of the seat back 3.

The belt retractor 36 is attached to the seat back frame 30 via a retractor protection cover 36a that is disposed to face the first opening portion 37a of the frame main body 37 and the opening portion 34a of the back plate 34. The seat belt (not illustrated) accommodated in the belt retractor 36 is looped via a shoulder anchor 36b provided on an upper-left portion of the seat back frame 30.

The garnish 5 includes a trim grill (trim member) 50 made of synthetic resin and forming a trim, a grill guide (second garnish) 51 made of synthetic resin and engaged with the trim grill 50, and an inner garnish (first garnish) 52 made of synthetic resin and engaged with the grill guide 51. The garnish 5 is formed to be attachable to the pair of right and left wire portions 81R and 81L of the garnish attachment portion 8. The inner garnish 52 is fitted to the pair of right and left wire portions 81R and 81L from the front side. The grill guide 51 and the inner garnish 52 are brought into abutment with each other and engaged with each other. The trim grill 50 is brought into abutment with and is engaged with the grill guide 51.

FIG. 6 is a perspective view of the trim grill 50 as viewed from the rear obliquely. As illustrated in FIG. 6, the trim grill 50 includes a grill main body (trim base portion) 501 extending in the left-right direction, and a frame portion 502 provided at an outer edge portion of the grill main body 501. The grill main body 501 is provided to cover the pair of right and left wire portions 81R and 81L of the garnish attachment portion 8, and is formed in a mesh shape penetrating in the front-rear direction. The frame portion 502 is provided along the outer edge portion of the grill main body 501, and includes a plurality of protruding portions (trim fixing portions) 503 projecting rearward from a rear surface (rear-side surface) 501R of the grill main body 501. The plurality of protruding portions 503 are provided at predetermined intervals, and each of the plurality of protruding portions 503 is provided with a locking claw 504 capable of locking the trim grill 50 to the grill guide 51.

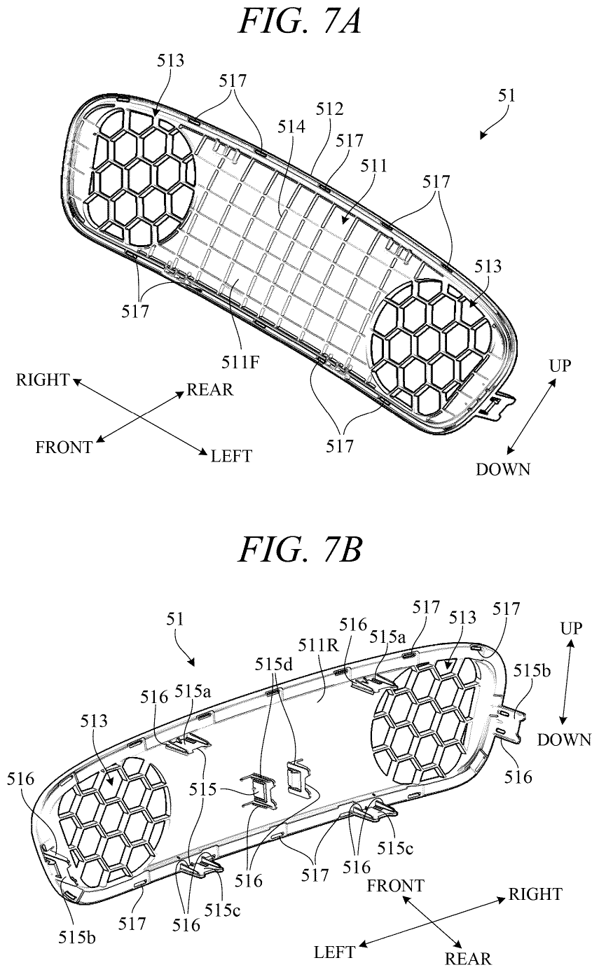

FIG. 7A is a perspective view of the grill guide 51 as viewed from the front, and FIG. 7B is a perspective view of the grill guide 51 as viewed from the rear. As illustrated in FIGS. 7A and 7B, the grill guide 51 has an outer shape substantially identical to that of the trim grill 50, and the trim grill 50 is brought into abutment with and engaged with the grill guide 51. Specifically, the grill guide 51 includes a guide main body 511 that extends in the left-right direction and has a shape substantially identical to that of the grill main body 501, and a frame portion 512 provided at an outer edge portion of the guide main body 511. The guide main body 511 includes a pair of left and right honeycomb portions 513 provided on both sides in the left-right direction. The honeycomb portions 513 include a plurality of honeycombs penetrating in the front-rear direction and are provided at positions facing a speaker unit 62 to be described later of the speaker system 6.

Ribs 514 are provided in a lattice shape on a front surface 511F of the guide main body 511, and the guide main body 511 abuts a rear surface 501R of the grill main body 501 through the ribs 514. On a rear surface (second bottom portion) 511R of the guide main body 511, a plurality of protruding portions (second standing wall portions) 515 project rearward. The plurality of protruding portions 515 include a pair of left and right first protruding portions 515a provided at an upper portion of the guide main body 511, a pair of left and right second protruding portions 515b provided at both end portions of the guide main body in the left-right direction, a pair of left and right third protruding portions 515c provided at a lower portion of the guide main body 511, and a pair of left and right fourth protruding portions 515d provided at a substantially center portion of the guide main body 511 in the left-right direction. Each of the first protruding portion 515a, the second protruding portion 515b, the third protruding portion 515c, and the fourth protruding portion 515d is provided with a locking claw 516 that enables the grill guide 51 to be locked to the inner garnish 52.

The frame portion 512 is provided along the outer edge portion of the guide main body 511, and the frame portion 512 is provided with a plurality of through-holes 517 through which a plurality of protruding portions 503 of the grill main body 501 penetrate. The plurality of through-holes 517 are provided to correspond to the positions of the plurality of protruding portions 503 of the trim grill 50 when the trim grill 50 and the grill guide 51 face each other, and the locking claw 504 of the protruding portion 503 that has penetrated the through-hole 517 is locked to the rear surface 511R of the guide main body 511.

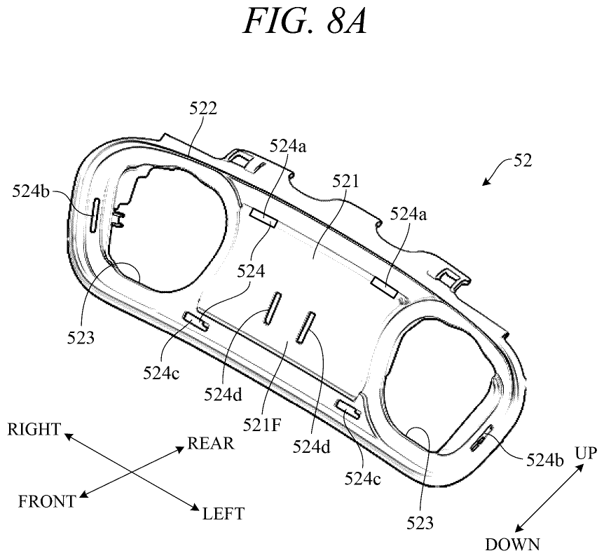

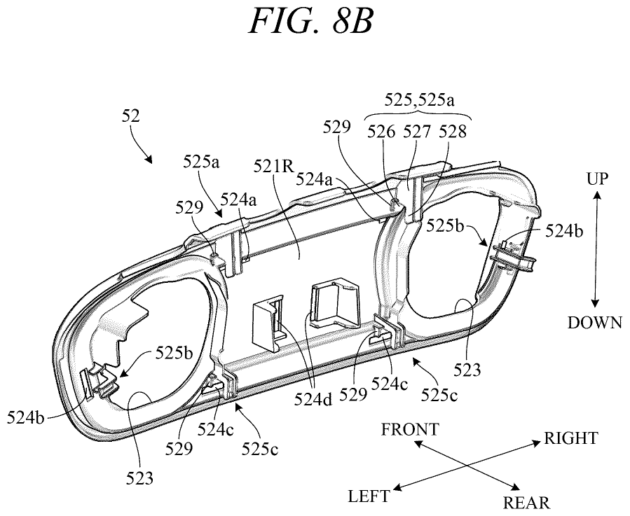

FIG. 8A is a perspective view of the inner garnish 52 as viewed from the front, and FIG. 8B is a perspective view of the inner garnish 52 as viewed from the rear. As illustrated in FIGS. 8A and 8B, the inner garnish 52 has an outer shape substantially identical to that of the grill guide 51, and the grill guide 51 is brought into abutment with and engaged with the inner garnish 52. Specifically, the inner garnish 52 includes an inner main body 521 extending in the left-right direction and having a shape substantially identical to that of the guide main body 511, and a frame portion 522 provided along the outer edge portion of the inner main body 521. The inner main body 521 includes a front surface 521F and a rear surface 521R, and a pair of left and right opening portions 523 provided on both sides in the left-right direction. The opening portions 523 face the honeycomb portions 513 of the guide main body 511 and also face the speaker unit 62 of the speaker system 6.

The inner main body 521 is provided with a plurality of through-holes 524 through which the plurality of protruding portions 515 of the guide main body 511 penetrate. Specifically, the plurality of through-holes 524 include a pair of first through-holes 524a through which the pair of first protruding portions 515a of the guide main body 511 penetrates, a pair of second through-holes 524b through which the pair of second protruding portions 515b penetrates, a pair of third through-holes 524c through which the pair of third protruding portions 515c penetrates, and a pair of fourth through-holes 524d through which the pair of fourth protruding portions 515d penetrates. The locking claws 516 of the first protruding portions 515a, the second protruding portions 515b, the third protruding portions 515c, and the fourth protruding portions 515d of the guide main body 511 penetrate through the first through-holes 524a, the second through-holes 524b, the third through-holes 524c, and the fourth through-holes 524d, respectively, in a state where the grill guide 51 faces the inner garnish 52, and are locked to the rear surface 521R of the inner main body 521.

On the rear surface 521R of the inner main body 521, a plurality of recessed portions (first recess portions) 525 formed in a recessed shape when viewed from the up-down direction or left-right direction, are provided at positions corresponding to the plurality of through-holes 524. The plurality of recessed portions 525 include a pair of first recessed portions 525a provided at positions corresponding to the pair of first through-holes 524a, a pair of second recessed portions 525b provided at positions corresponding to the pair of second through-holes 524b, and a pair of third recessed portions 525c provided at positions corresponding to the pair of third through-holes 524c.

Each of the first recessed portion 525a, the second recessed portion 525b, and the third recessed portion 525c includes a bottom portion (first bottom portion) 526 of the rear surface 521R, a standing wall portion (first standing wall portion) 527 protruding rearward from the bottom portion 526, and an extension portion (first extension portion) 528 extending substantially at a right angle from the standing wall portion 527. The pair of right and left wire portions 81R and 81L of the garnish attachment portion 8 is positioned in a space surrounded by the bottom portion 526, the standing wall portion 527, and the extension portion 528. Specifically, each upper wire 84 of the pair of right and left wire portions 81R and 81L is positioned in the space surrounded by the bottom portion 526, the standing wall portion 527, and the extension portion 528 of the pair of first recessed portions 525a. Each side wire 85 of the pair of right and left wire portions 81R and 81L is positioned in the space surrounded by the bottom portion 526, the standing wall portion 527, and the extension portion 528 of the pair of second recessed portions 525b. Each lower wire 86 of the pair of right and left wire portions 81R and 81L is positioned in the space surrounded by the bottom portion 526, the standing wall portion 527, and the extension portion 528 of the pair of third recessed portions 525c.

A relief portion 529 recessed in a thickness direction is provided in each bottom portion 526 of the pair of first recessed portions 525a, the pair of second recessed portions 525b, and the pair of third recessed portions 525c. Thus, the pair of right and left wire portions 81R and 81L can be easily guided to the pair of first recessed portions 525a, the pair of second recessed portions 525b, and the pair of third recessed portions 525c. The distal end of each extension portion 528 of the pair of first recessed portions 525a, the pair of second recessed portions 525b, and the pair of third recessed portions 525c is formed to be elastically deformed in a direction away from the bottom portion 526. Thus, the pair of right and left wire portions 81R and 81L can be more easily guided to the pair of first recessed portions 525a, the pair of second recessed portions 525b, and the pair of third recessed portions 525c.

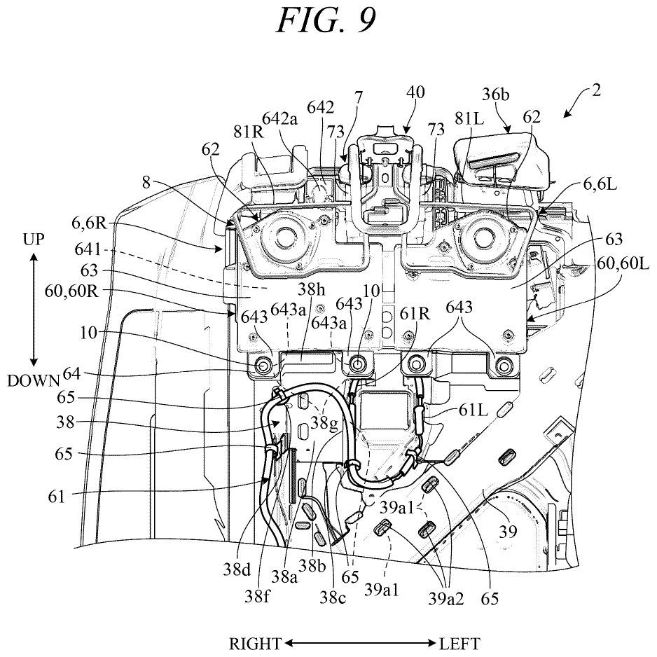

FIG. 9 is a front view illustrating a configuration of the speaker system 6 fixed to the seat back frame 30. As illustrated in FIG. 9, the speaker system 6 includes a pair of right and left speaker systems 6R and 6L having the same configuration. Each of the pair of right and left speaker systems 6R and 6L includes a speaker device (electrical component main body) 60 and the wiring portion 61 connected to the speaker device 60.

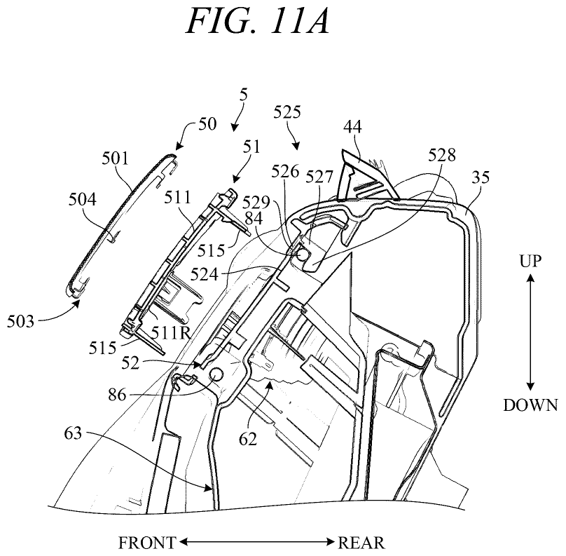

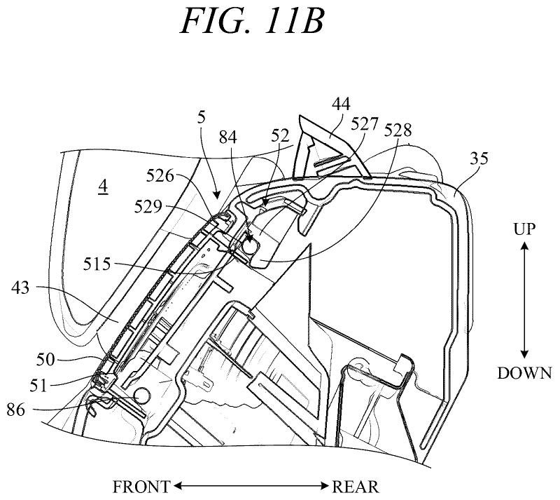

The speaker device 60 includes the speaker unit 62 that outputs sound, a speaker box 63 that supports the speaker unit 62, and a rear casing 64 that fixes the speaker box 63 to the seat back frame 30. Although a detailed description is omitted, the speaker unit 62 is a general cone-type unit. The speaker box 63 supports the speaker unit 62 such that the speaker unit 62 faces the honeycomb portions 513 of the guide main body 511 and the opening portions 523 of the inner main body 521, and is formed to have a recessed shape which is recessed downward and rearward from the support portion of the speaker unit 62 (refer to FIG. 11A). As a result, the speaker box 63 can be disposed without impairing the seating comfort of the occupant.

Each of the pair of left and right rear casings 64 has a casing main body 641 joined to the rear surface of the speaker box 63, a first extension portion 642 extending upward from the upper end portion of the substantially center portion of the casing main body 641 in the left-right direction, and a pair of left and right second extension portions 643 extending downward from the lower end portions of both end portions of the casing main body 641 in the left-right direction.

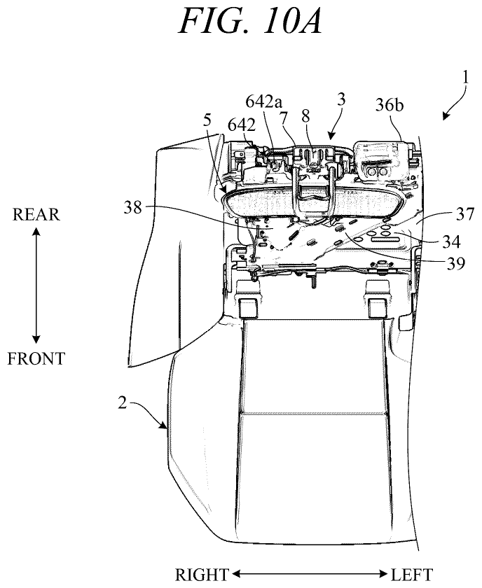

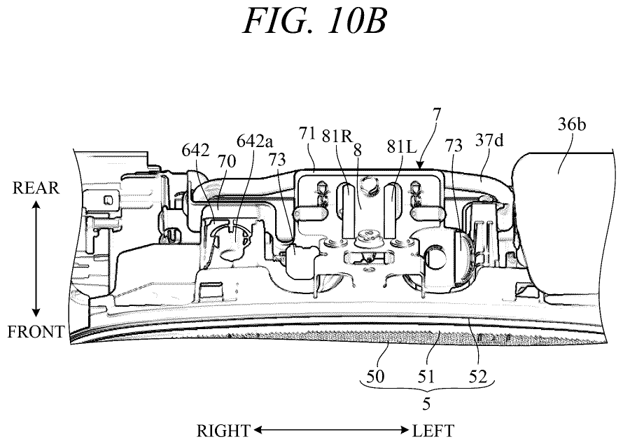

FIG. 10A illustrates a plan view of the first extension portion 642 of the rear casing 64 as viewed from above, and FIG. 10B illustrates an enlarged view of the first extension portion 642 of FIG. 10A. As illustrated in FIGS. 9, 10A, and 10B, the first extension portion 642 includes a first fixing portion 642a. The first fixing portion 642a is provided with a through-hole.

The first fixing portion 642a is provided to face the fixing portion 70a (FIG. 5) provided on the holding portion main body 70 of the headrest holding portion 7. A pair of left and right pillar guide portions 73 is provided on the front surface of the holding portion main body 70 of the headrest holding portion 7 (FIG. 5). Therefore, the rear casing 64 is fixed to the headrest holding portion 7 via the first fixing portion 642a of the first extension portion 642, which is positioned at substantially the same position as the pair of left and right pillar guide portions 73 in the up-down direction.

Each of the pair of left and right second extension portions 643 includes a second fixing portion 643a. The second fixing portion 643a is provided with a through-hole, and the pair of second fixing portions 643a is provided to face the fixing portions 38g1 (FIG. 4) of the pair of sixth extension portions 38g provided on the reinforcement plate 38. A lower end portion of the rear casing 64 is fixed to a frame main body 37 and the reinforcement plate 38 via the second fixing portions 643a of the pair of second extension portions 643. In other words, the lower end portion of the rear casing 64 is fixed in an overlapping manner at a position where the frame main body 37 and the reinforcement plate 38 overlap each other.

The wiring portion 61 is connected to the speaker unit 62 and an amplifier (not illustrated). A sound signal output from the amplifier is input to the speaker unit 62 via the wiring portion 61. As illustrated in FIG. 9, the wiring portion 61 extends upward from the lower side of the seat back 3 and is fixed to the seat back frame 30 at multiple locations via the clips 65.

The wiring portion 61 is supported at multiple locations by the reinforcement plate 38. Specifically, the wiring portion 61 is supported to extend in the up-down direction at the first extension portion 38b, the second extension portion 38c, and the third extension portion 38d of the reinforcement plate 38 via the clips 65. The first extension portion 38b and the fourth extension portion 38e are provided at substantially the same position in the up-down direction (FIG. 4). The wiring portion 61 is supported at the same position as the joint portion 38e1 of the fourth extension portion 38e in the up-down direction.

The wiring portion 61 is supported to extend in the left-right direction at the fifth extension portion 38f of the reinforcement plate 38 via the clips 65. The fifth extension portion 38f is provided above the fourth extension portion 38e (FIG. 4). Therefore, the support portion 38f1 of the fifth extension portion 38f is provided between the joint portion 38e1 of the fourth extension portion 38e and the speaker device 60. As illustrated in FIG. 4, the joint portion 38e1 of the fourth extension portion 38e is provided, in the up-down direction, between the support portion 38d1 of the third extension portion 38d and the support portion 38f1 of the fifth extension portion 38f, and is provided, in the left-right direction, between the support portion 38b1 of the first extension portion 38b and the support portion 38d1 of the third extension portion 38d.

In this manner, the wiring portion 61 is supported to extend in the up-down direction on the right side of the reinforcement plate 38 by the third extension portion 38d, is supported to extend in the left-right direction on the upper side of the reinforcement plate 38 by the fifth extension portion 38f, and is supported to extend in the up-down direction on the left side of the reinforcement plate 38 by the second extension portion 38c. The wiring portion 61 is supported at different positions in the up-down direction by the respective extension portions 38d, 38f, and 38c. Furthermore, the wiring portion 61 branches into two on the left side of the second extension portion 38c, and a pair of wiring portions 61L and 61R extends upward toward the speaker unit 62 of each of the pair of right and left speaker systems 6R and 6L, and is connected to the speaker unit 62. One of the wiring portions 61, which is connected to the speaker unit 62 of the speaker system 6R, is supported by the first extension portion 38b.

The seat back 3 configured as described above is manufactured as follows. First, the reinforcement plate 38 and the reinforcement plate 39 are joined to the frame main body 37 by welding or the like (FIGS. 2 and 9). Next, the garnish attachment portion 8 and the headrest holding portion 7 are fixed to the frame main body 37 by bolts and nuts 11, and are also joined by welding (FIG. 5). As a result, the seat back frame 30 is formed.

Next, the speaker system 6 is attached to the seat back frame 30. First, the lower end of the speaker device 60 is positioned by being brought into abutment with the abutting portion 38h1 (FIG. 4) formed in the vicinity of the rib 38h of the reinforcement plate 38. Next, the pair of second extension portions 643 of the rear casing 64 is fixed to the fixing portions 38g1 (FIG. 4) of the pair of sixth extension portions 38g of the reinforcement plate 38 by bolts 10 and nuts (FIG. 9). As a result, the speaker device 60 is attached to the seat back frame 30 so as to overlap the reinforcement plate 38 in the front-rear direction.

Next, the first extension portion 642 of the rear casing 64 is fixed to the fixing portion 70a (FIG. 5) of the holding portion main body 70 of the headrest holding portion 7 by bolts and nuts (FIG. 9). As a result, the first extension portion 642 of the rear casing 64 is fixed between the pair of left and right second extension portions 643 of the rear casing 64.

Next, the inner garnish 52 is attached to the pair of right and left wire portions 81R and 81L of the garnish attachment portion 8. Specifically, the pair of right and left wire portions 81R and 81L of the garnish attachment portion 8 is engaged in spaces (FIG. 8B) surrounded by the bottom portions 526, the standing wall portions 527, and the extension portions 528 of the plurality of recessed portions 525 of the inner garnish 52 by flexing the standing wall portions 527 and the extension portions 528. The relief portion 529 is provided on each bottom portion 526 of the plurality of recessed portions 525 of the inner garnish 52, and the distal end of the extension portion 528 is formed to be bendable in a direction away from the bottom portion 526. As a result, the pair of right and left wire portions 81R and 81L can be easily engaged with the first recessed portion 525a, the second recessed portion 525b, and the third recessed portion 525c.

Next, the grill guide 51 and the trim grill 50 are attached to the inner garnish 52. FIG. 11A is a sectional view illustrating a state where the grill guide 51 and the trim grill 50 are in the middle of being attached to the inner garnish 52, and FIG. 11B is a sectional view illustrating a state after the grill guide 51 and the trim grill 50 are attached to the inner garnish 52.

As illustrated in FIGS. 11A and 11B, first, the pair of protruding portions 515 formed on the rear surface 511R of the guide main body 511 of the grill guide 51 is inserted into the pair of through-holes 524 formed on the inner main body 521 of the inner garnish 52. As a result, the grill guide 51 is locked to the inner garnish 52. At this time, the protruding portions 515 of the grill guide 51 face the recessed portions 525 of the inner garnish 52, and the upper wires 84, the side wires 85, and the lower wires 86 of the pair of right and left wire portions 81R and 81L are arranged to be surrounded by the recessed portions 525 and the protruding portions 515. The protruding portion 515 is formed to be spaced apart from the extension portion 528 in a state where the grill guide 51 is locked to the inner garnish 52, and thereby the occurrence of abnormal noise due to the contact between the protruding portion 515 and the extension portion 528 can be suppressed.

Next, the plurality of protruding portions 503 of the trim grill 50 are inserted into the plurality of through-holes 517 (FIG. 7A) of the grill guide 51, and the trim grill 50 is engaged with the grill guide 51. At this time, the distal ends of the plurality of protruding portions 503 of the trim grill 50 are positioned between the rear surface of the grill guide 51 and the front surface of the inner garnish 52. In addition, since lattice-shaped ribs 514 (FIG. 7A) are provided on the front surface 511F of the guide main body 511 of the grill guide 51, the grill main body 501 and the guide main body 511 come into abutment with each other via the ribs 514.

Next, the belt retractor 36 is attached to the seat back frame 30 via the retractor protection cover 36a (FIG. 3). Furthermore, remaining components such as the front plate 33, the back plate 34, and the rear cover 35 are attached to the seat back frame 30. Finally, the seat back pad 31 is attached to the seat back frame 30, and the cover material 32 is further placed over the outer side thereof, thereby forming the seat back 3 (FIG. 1).

According to the present embodiment, the following operations and effects are achievable.
(1) The seat 1 according to the present embodiment includes the seat back frame 30, and the speaker system 6 that is attached to the seat back frame 30 (FIG. 1). The seat back frame 30 includes the frame main body 37, and the reinforcement plate 38 that reinforces the frame main body 37 (FIG. 2). The speaker system 6 includes the speaker device 60, and the wiring portion 61 connected to the speaker device 60 (FIG. 2). At least a portion of the speaker device 60 is attached to overlap the frame main body 37 and the reinforcement plate 38 in the front-rear direction, that is, to overlap in a front view as viewed from the front, and the wiring portion 61 is supported by the reinforcement plate 38 (FIG. 2).

With this configuration, the wiring portion 61 can be arranged at a portion where the rigidity has been increased by the reinforcement plate 38 of the frame main body 37. Therefore, it is possible to suppress deformation of the wiring portion 61 due to the action of a bending load or the like on the wiring portion 61. In addition, the support portion that supports the wiring portion 61 can be provided at a portion where the frame main body 37 and the reinforcement plate 38 overlap each other, and the wiring portion 61 can be firmly supported without reducing the rigidity of the frame main body 37.
(2) The reinforcement plate 38 is joined to the frame main body 37 (FIG. 2). The wiring portion 61 is supported by the reinforcement plate 38 at the same position in the up-down direction as the joint portion 38e1 between the reinforcement plate 38 and the frame main body 37 (FIG. 9). With this configuration, the wiring portion 61 can be supported at a portion having higher rigidity.
(3) The wiring portion 61 is supported by the plurality of support portions 38b1, 38c1, 38d1, and 38f1 provided on the reinforcement plate 38 (FIGS. 4 and 9). As a result, the reinforcement plate 38 can function not only as a reinforcement portion but also as a support portion for supporting the wiring portion 61.
(4) The wiring portion 61 is supported to extend substantially in the up-down direction (first direction) by the support portions 38b1, 38c1, and 38d1, and is supported to extend substantially in the left-right direction (second direction) by the support portion 38f1 (FIGS. 4 and 9). As a result, since the wiring portion 61 extends in multiple directions, routing of the wiring portion 61 is facilitated, and interference between multiple wiring portions 61 can be avoided.
(5) The reinforcement plate 38 includes the central plate portion 38a (first plate portion) that extends in the up-down direction and the left-right direction, the fifth extension portion 38f (second plate portion) that extends along the central plate portion 38a from the right end portion of the central plate portion 38a, and the first extension portion 38b, the second extension portion 38c, and the third extension portion 38d (third plate portion) that extend rearward from both left and right end portions of the central plate portion 38a (FIG. 4). The plurality of support portions 38b1, 38c1, 38d1, and 38f1 are provided on the first extension portion 38b, the second extension portion 38c, the third extension portion 38d, and the fifth extension portion 38f (FIG. 4). As a result, a support position of the wiring portion 61 can be clearly defined, and the wiring portion 61 can be prevented from being supported at an incorrect location.
(6) The support portion 38f1 is provided to be located at a different position from the other support portions 38b1, 38c1, 38d1, and 38f1 in the up-down direction (FIG. 4). As a result, the wiring portion 61 can be satisfactorily supported at a plurality of different positions in the up-down direction.
(7) The speaker device 60 is attached to the front surface of the frame main body 37 (FIG. 9). The reinforcement plate 38 is joined to the front surface of the frame main body 37 via the plurality of joint portions 38a1 such that the front end portion of the reinforcement plate 38 is positioned rearward of the front end portion of the speaker device 60 (FIG. 9). The support portion 38f1 supports the wiring portion 61 such that the wiring portion 61 extends in the left-right direction, and is provided below the speaker device 60 and above the joint portion 38a1 on the lower side among the plurality of joint portions 38a1 (FIG. 9). With this configuration, since the wiring portion 61 is supported rearward of the front end of the speaker device 60 and above the joint portion 38a1 on the lower side, excessive pressure acting on the wiring portion 61 due to a load applied from the front can be suppressed.
(8) The plurality of support portions include the support portions 38b1 and 38c1 that are provided on the left side of the reinforcement plate 38 and support the wiring portion 61 in a state where the wiring portion 61 extends in the up-down direction, and the support portion 38d1 that is provided on the right side of the reinforcement plate 38 and supports the wiring portion 61 in a state where the wiring portion 61 extends in the up-down direction (FIG. 4). One of the two joint portions 38a1 is provided, in the up-down direction, between the support portion 38f1 and one of the support portions 38b1 and 38c1 or the support portion 38d1, and is provided, in the left-right direction, between the support portions 38b1 and 38c1 and the support portion 38d1. As a result, workability when the wiring portion 61 is attached can be improved.
(9) The support portions include the support portion 38c1 (first-end-side first support portion) provided at the left end portion (first end portion) of the reinforcement plate 38, and the support portion 38d1 (second-end-side first support portion) provided at the right end portion (second end portion) of the reinforcement plate 38 (FIG. 4). The support portion 38f1 is provided above the support portion 38d1 (FIG. 4). The wiring portion 61 is supported to extend in the up-down direction by the support portion 38c1 and the support portion 38d1, and is supported to extend in the left-right direction by the support portion 38f1 (FIG. 9). As a result, the wiring portion 61 can be arranged while being bent with a gentle curvature.
(10) The wiring portion 61 extends in the left-right direction and branches into two on the left side and the lower side of the support portion 38c1, and the pair of branched wiring portions 61L and 61R extends upward (FIG. 9). As a result, the wiring portion can be arranged in a branched manner while being gently bent.
(11) The speaker device 60 includes the speaker device 60R (first electrical component main body) that is arranged above the reinforcement plate 38 and at the same position as the reinforcement plate 38 in the left-right direction, and the speaker device 60L (second electrical component main body) that is arranged on the left side of the speaker device 60R (FIG. 9). The pair of wiring portions 61L and 61R is connected to the left and right speaker devices 60L and 60R, respectively (FIG. 9). As a result, the wiring portion 61 can be easily connected to the plurality of speaker devices 60L and 60R above the reinforcement plate 38.

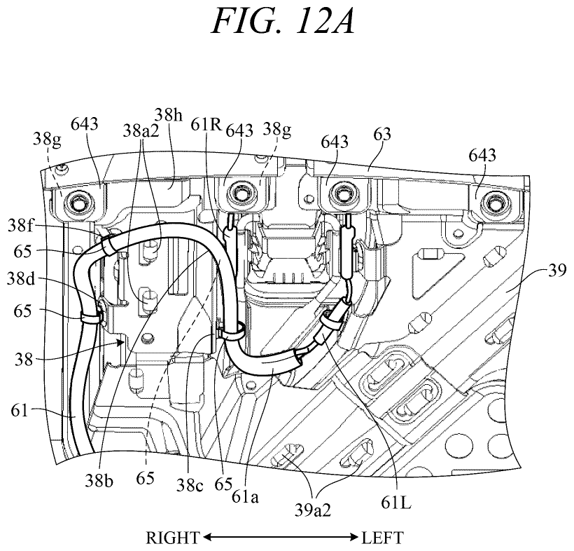

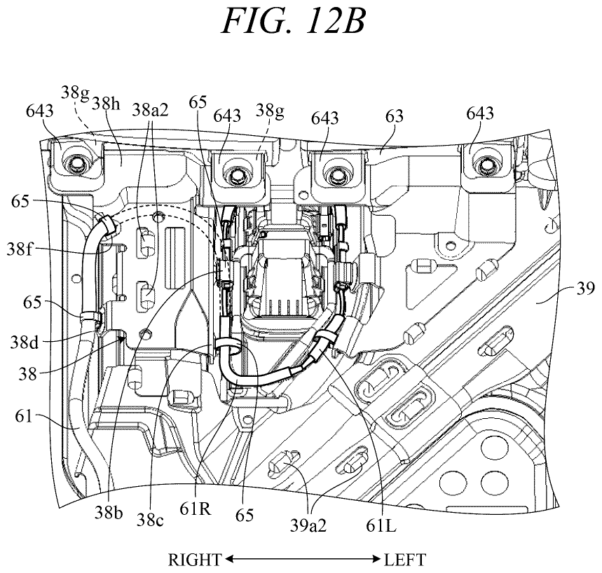

The above embodiment may be modified in various forms. FIGS. 12A and 12B are examples illustrating modifications of the wiring portion 61 of the speaker system 6. FIG. 12A is a perspective view as viewed from a position in front of and obliquely above the seat back 3, and FIG. 12B is a front view as viewed from a front. In the example illustrated in FIGS. 12A and 12B, the length of one wiring portion 61 extending from the branching portion 61a, which branched into two on the left side of the second extension portion 38c, differs from the length of the other wiring portion. Specifically, one wiring portion 61R, which connects from the branching portion 61a to the speaker unit 62 of the speaker system 6R, is longer than the other wiring portion 61L, which connects to the speaker unit 62 of the speaker system 6L. By making the lengths of the one and the other wiring portions 61L and 61R, which branch into two in this manner, different from each other, it is possible to prevent the wiring portions 61 from being mistakenly connected to the respective speaker units 62 of the left and right speaker systems 6R and 6L.

In the above embodiment, a speaker unit is used as an electrical component, but the electrical component is not limited to this. For example, other devices capable of enhancing occupant convenience and comfort, such as a massage device built into the seat or a microphone device for voice input of commands to various vehicle equipment, can also be used as the electrical component.

In the above embodiment, an automobile rear seat is used as a vehicle seat, the vehicle seat is not limited to this. For example, the vehicle seat of the present invention can also be applied to the front seats, such as the driver's seat or passenger seat, of an automobile, or to seats installed in vehicles other than automobiles.

The above embodiment can be combined as desired with one or more of the above modifications. The modifications can also be combined with one another.

According to the present invention, bending loads and the like acting on a wiring portion housed inside a vehicle seat can be suppressed.

Above, while the present invention has been described with reference to the preferred embodiments thereof, it will be understood, by those skilled in the art, that various changes and modifications may be made thereto without departing from the scope of the appended claims.

What is claimed is:

1. A vehicle seat comprising:
a frame part; and
an electrical component attached to the frame part, wherein
the frame part includes a frame main body and reinforcement portion reinforcing the frame main body,
the electrical component includes an electrical component main body and a wiring portion connected to the electrical component main body,
at least a portion of the electrical component main body is attached so as to overlap the frame main body and the reinforcement portion in a front view as viewed from a front, and
the wiring portion is supported by the reinforcement portion.

2. The vehicle seat according to claim 1, wherein
the reinforcement portion is joined to the frame main body, and
the wiring portion is supported by the reinforcement portion at a same position in a up-down direction as a joint portion between the reinforcement portion and the frame main body.

3. The vehicle seat according to claim 1, wherein
the wiring portion is supported by a plurality of support portions provided on the reinforcement portion.

4. The vehicle seat according to claim 3, wherein
the plurality of support portions includes a first support portion and a second support portion, and
the wiring portion is supported by the first support portion so as to extend in a first direction, and is supported by the second support portion so as to extend in a second direction different from the first direction.

5. The vehicle seat according to claim 3, wherein
the reinforcement portion includes a first plate portion extending in an up-down direction and a left-right direction, a second plate portion extending along the first plate portion from an end portion of the first plate portion, and a third plate portion extending in a front-rear direction from another end portion of the first plate portion, and
the plurality of support portions are provided on the second plate portion and the third plate portion.

6. The vehicle seat according to claim 4, wherein
The second support portion is provided at a position different in an up-down direction from a position of the first support portion.

7. The vehicle seat according to claim 4, wherein
the electrical component main body is attached to a front surface of the frame main body,
the reinforcement portion is joined to the front surface of the frame main body through a plurality of joint portions such that a front end portion of the reinforcement portion is located rearward of a front end portion of the electrical component main body, and
the second support portion is configured to support the wiring portion such that the wiring portion extends in a left-right direction, and is provided below the electrical component main body and above at least one of the plurality of joint portions.

8. The vehicle seat according to claim 7, wherein
the first support portion includes a left first support portion provided on a left side of the reinforcement portion to support the wiring portion in a state extending in an up-down direction, and a right first support portion provided on a right side of the reinforcement portion to support the wiring portion in a state extending in the up-down direction, and
any one or more of the plurality of joint portions is provided, in the up-down direction, between the second support portion and at least one of the left first support portion and the right first support portion, and is provided, in the left-right direction, between the left first support portion and the right first support portion.

9. The vehicle seat according to claim 4, wherein
the first support portion has a first end-side first support portion provided at a first end portion in a left-right direction of the reinforcement portion and a second end-side first support portion provided at a second end portion in the left-right direction of the reinforcement portion,
the second support portion is provided above the second end-side first support portion, and
the wiring portion is supported by the first end-side first support portion and the second end-side first support portion so as to extend in an up-down direction, and by the second support portion so as to extend in the left-right direction.

10. The vehicle seat according to claim 9, wherein
the wiring portion extends in the left-right direction below and on a side in the left-right direction of the first end-side first support portion, and branches into two, and
a pair of branched wiring portions extend upward.

11. The vehicle seat according to claim 10, wherein
the electrical component main body includes a first electrical component main body disposed above the reinforcement portion and at a same position as the reinforcement portion in the left-right direction, and a second electrical component main body disposed at a side in the left-right direction of the first electrical component main body, and
the pair of branched wiring portions are connected to the first electrical component main body and the second electrical component main body, respectively.
